(19) United States
(12) Patent Application Publication
(10) Pub. No.: US 2012/0274856 A1
(43) Pub. Date: Nov. 1, 2012

(54) Frame List Processing for Multiple Video Channels

(76) Inventors: Purushotam Kumar, Bangalore (IN); Sivaraj Rajamonickam, Bangalore (IN); Brijesh Rameshbhai Jadav, Bangalore (IN); Kedar Chitnis, Bangalore (IN)

(21) Appl. No.: 13/095,445

(22) Filed: Apr. 27, 2011

(51) Int. Cl. H04N 9/67

(52) U.S. Cl. 348/660; 348/E05.108

(57) ABSTRACT

A driver for operating an electronic device including a program controlled data processor and video processing hardware responsive to requests to perform operations on video frames is provided. A frame list is formed with pointers to a plurality of buffers for a corresponding plurality of video channels. A request is formed by an application program running on the data processor for a first operation on each of the plurality of frames in the first frame list. The request of the application program and the first frame list is submitted to a driver for the video processing hardware for the plurality of channels. A notification is received from the driver when the video processing hardware has completed the operation on less than all of the plurality of frames.

### FIELD OF THE INVENTION

This invention generally relates to video processing in hardware engines, and more particularly to providing a driver for multiple video channel processing.

### BACKGROUND OF THE INVENTION

Typically, a video processing solution is composed of hardware accelerators (HWAs), connected to a central programmable unit (CPU) that is in charge of initializing and starting the different hardware accelerators along with managing all their input/output data transfers. As the image resolutions to be processed become higher and video standards become more complex, the number of hardware accelerators needed to support such features may increase. Thus the task scheduling on the different HWAs may become a bottleneck that requires increased processing capabilities in the CPU. Increasing performance of the CPU may be detrimental to size and power usage.

In a typical implementation, all nodes are activated and controlled by the central CPU. Data can be exchanged between nodes and the CPU either by a common memory or by DMA (direct memory access). The CPU typically responds to interrupt requests from the various HWAs to schedule tasks.

Video drivers are software used to control the video hardware in a system and program the hardware to transfer video data to/from video devices. The application gives a buffer to the driver to start a video operation. This is called queue operation. Once the buffer is done processing, the application gets the queued buffer back from the driver. This is called dequeue operation. Known driver interfaces, such as V4L2 or FBDEV, do not support multiple channel capture as well as a memory driver interface under a single interface.

### BRIEF DESCRIPTION OF THE DRAWINGS

Particular embodiments in accordance with the invention will now be described, by way of example only, and with reference to the accompanying drawings:

FIG. 1 is a block diagram of a video processing system that embodies an aspect of the present invention;

FIGS. 2A-2D are illustrations of various organizations of frame buffers;

FIG. 3 is an illustration of frame lists;

FIG. 4 illustrates a relation between video processing hardware and process lists;

FIG. 5 is a flow diagram illustrating a system with multi-window processing;

FIG. 6 is a flow diagram illustrating multi-channel capture;

FIG. 7 is a flow diagram illustrating single queue, multiple dequeue operations;

FIG. 8 illustrates use of frame lists for multiple dequeue operation; and

FIG. 9 is a block diagram of a video processing device that embodies an aspect of the present invention.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the invention provide a video driver interface addressing limitation of existing video driver interface for multi-channel video systems, including support of multi-window display or processing operation and support of capturing of multiple video channels. In this context, the term “display” means displaying of video content through the video hardware on display devices like TV, LCD etc. The term “capture” means capturing of digitized video content from devices like camera, DVD players etc. Video processing involves operations like scaling, noise filtering, de-interlacing etc. A “frame” refers to one frame of video or graphics data. Number of frames per second could be 30/50/60, for example, depending on the mode selected. More specifically, “frame” as used herein means a buffer pointer for a buffer which holds video data in YUV or RGB format and meta data, such as position on screen, size, scaling parameters, field id, time stamp etc. A frame list is defined as a container which holds multiple frames. A process list is another container which holds multiple frame lists.

In the case of capture, “channel” means an input video source such as a camera which is represented by “frame” in software and input from multiple channel/camera is represented as “frame list” where each capture video data of channel/camera goes into one “frame” with meta data like time stamp, field id etc of frame list. Number of “frames” in “frame list” is same as number of captured video from camera/channel.

In the case of display, there are cases where multiple frame will require to be shown on single display. For example, say four frames of size 960 *540 frames will make single 1920*1080 frames. In this case, four frames of size 960 *540 will be at different location in the memory and application will provide four “frames” with size and position where it has to be displayed on screen of size 1920*1080. Now these four frames for display could be called as “window” or “channel”. It is generally referred to as “channel” for capture and “window” for display. These are logical names and actually represents four distinct sets of video data with size, field id, position (in the case display).

With the emerging new video market, there is a need to process multiple video channels at the same time such as in video surveillance and security digital video recorders. As used herein, the term “channel” refers to each video input source, such as camera 1, 2, etc.

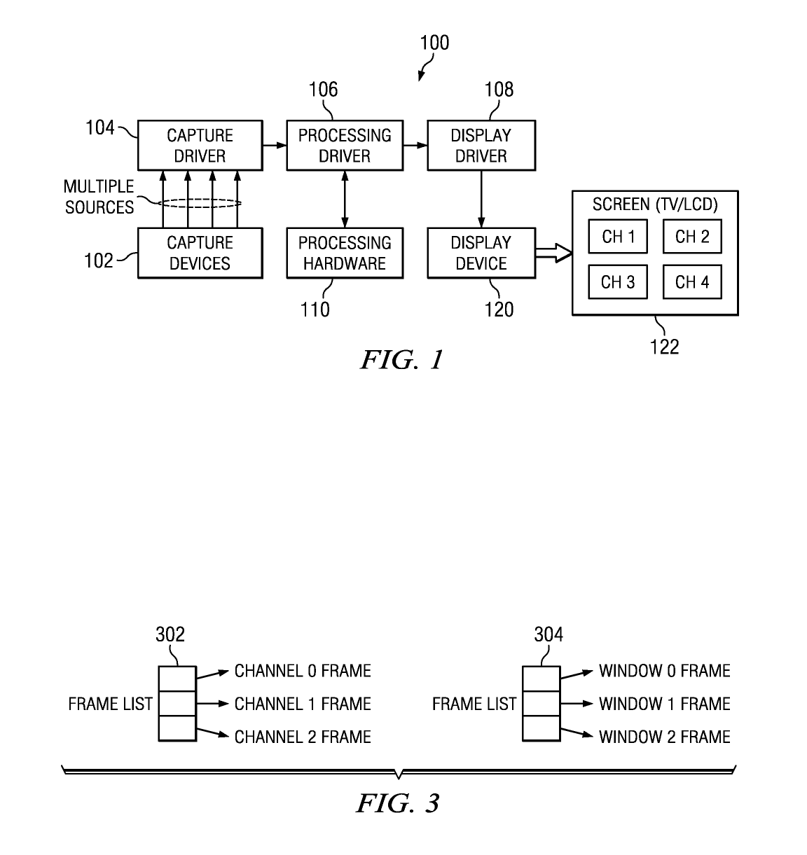

FIG. 1 is a block diagram of a video processing system 100 that embodies an aspect of the present invention. A typical multi-channel video application may have the following sequence. First, capture of video frames using capture driver 104 from multiple video sources 102. The video sources may be cameras, data feeds received over a wired or wireless network, files from a mass storage device, etc.

Next, optional noise filter/scale/de-interlacing the video frames may be performed using video processing hardware 110 using processing drivers 106. The frames are then displayed using a display driver 108 on a display device 120. While displaying, the different videos could be resized/scaled and positioned at different locations in the screen 122, where screen 122 is representative of what is being displayed by display device 120. This is called composition. The processing methods and techniques, as well as methods and devices for displaying the composed image, are known and therefore will not be described in detail herein.

Video drivers 104, 106, 108 are software used to control the video hardware in a system and program the hardware to transfer video data to/from video devices. The application gives a buffer to the driver to start a video operation. This is called queue operation. Once the buffer is done processing, the application gets back the queued buffer from the driver. This is called dequeue operation. There could be callbacks from the driver to the application to indicate that the request is completed.

Many video processors are capable of processing multiple channels, which means the video processor is able to capture multiple channels, process all of them and then display them. In a typical example system 100, there may be a software overhead allowance of around 20% for processing all the channels. However, with the prior art video driver interfaces, only one channel can be given to the driver for processing whether it is capture, processing or display operation. The software overhead for this system may be somewhere around 20% to 30% for a single channel operation. So for multi channel video systems with 16 channels, this software overhead could be very high if prior art drivers are used and hence the hardware and the software together cannot achieve the expected number of channels.

Limitation of the prior art video driver interfaces include the following:

Interface does not support display of frames with multiple windows i.e. video composition;

Interface does not support capture of multiple channels in a single request;

Interface does not support multiple request processing in case of video processing drivers; and

Interfaces are different for display, capture and processing (memory to memory) drivers. An application generally has to deal with different set of interfaces for each operation which makes the system complex and decreases performance because of copying of data structure when moving from one application programming interface (API) to other APIs for display, capture etc.

A video driver interface used in drivers 104, 106 and 108 embodying aspects of the invention provides a standard set of interfaces for video hardware whether it is a display, capture, or video processing. Video processing may include memory to memory operations such as scaling. In addition to these features, the improved driver interface may support several additional features. In some embodiments, it may provide an interface to support multi-window operation which means that a single frame of video is represented by multiple windows or buffers possibly scattered in memory. Source of video for each window could be different like from DVD, camera 1, 2 etc. This feature is also called as composition of several video into single frame.

In some embodiments, the improved driver interface may support capture of multiple channels of video stream in a single request operation which is also scalable for single channel capture in the conventional system.

In some embodiments, the improved driver interface may support one input request and one or multiple output request/intimation. In traditional systems, buffers are queued to the driver and the queued buffers are returned to the application using a single function call. There is always a one to one correspondence between a queue and a dequeue call. But in the case of multiple channel capture, the input sources could be asynchronous to each other i.e. the capture of each channels could happen at different point of time. For example the application could queue 16 buffers to the driver to capture video from 16 cameras. At time t0, only 5 of the 16 videos may be captured. The remaining videos may be captured at time t1. If the correspondence between queue and dequeue call is maintained, then the buffers could only be returned to the application at time t1 which could result in latency for the captured channels at time t0. In the improved interface, this correspondence is delinked. A queue call could have multiple dequeue calls or vice versa.

In some embodiments, the improved driver interface may support changing of hardware parameters at runtime on a frame to frame basis.

Embodiments of the invention define a consistent and standard interface for all the types of video drivers, such as display, capture and memory-to-memory, with a common set of data structures and function prototypes.

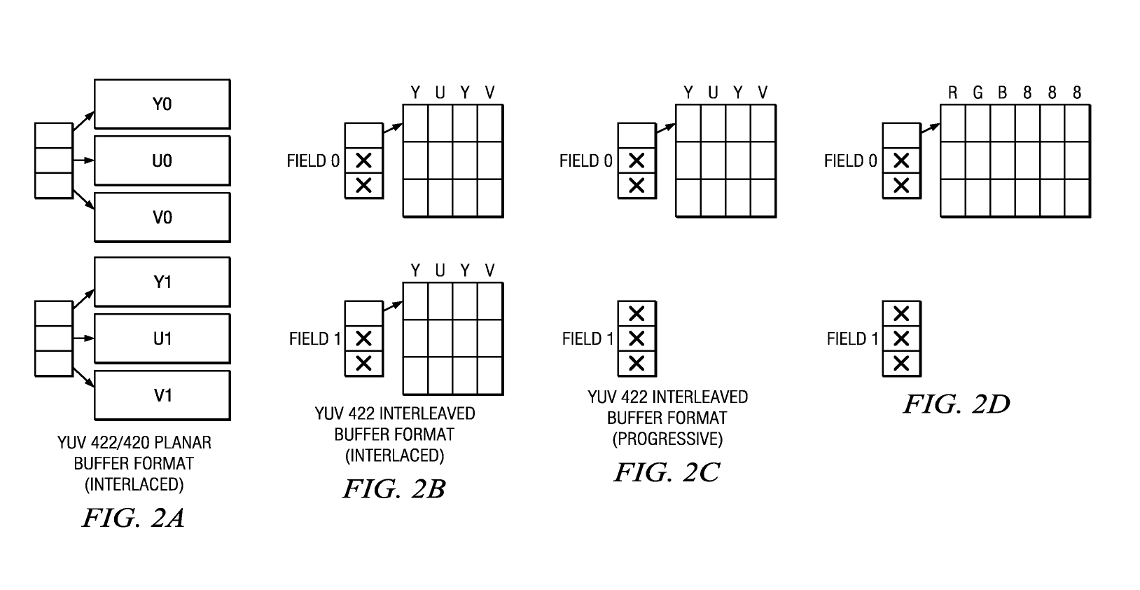

FIGS. 2A-2D are illustrations of various organizations of frame buffers that are supported by the improved driver interface. A frame represents the video frame buffer along with other meta data. This is the entity which is exchanged between driver and application and not the buffer address pointers. Meta data may include timestamp, field ID, per frame configuration, application data etc. Since video buffers can have up to three planes and two fields (in the case of YUV planar interlaced), buffer addresses in the improved driver interfaces are represented using a two dimensional array of pointers of size 2 (field)×3 (planes).

FIG. 3 is an illustration of frame lists used in the improved driver interface. A frame list represents N different frames. The N frames may represent different capture channels in multi channel capture. Some or all of the N frames may also represent a buffer address for each of the windows in multi window mode for display or composition of multiple small video to create single frame for display. For example, frame list 302 represents different capture channels in multi channel capture, while frame list 304 represent a buffer address for each of the windows in multi window mode.

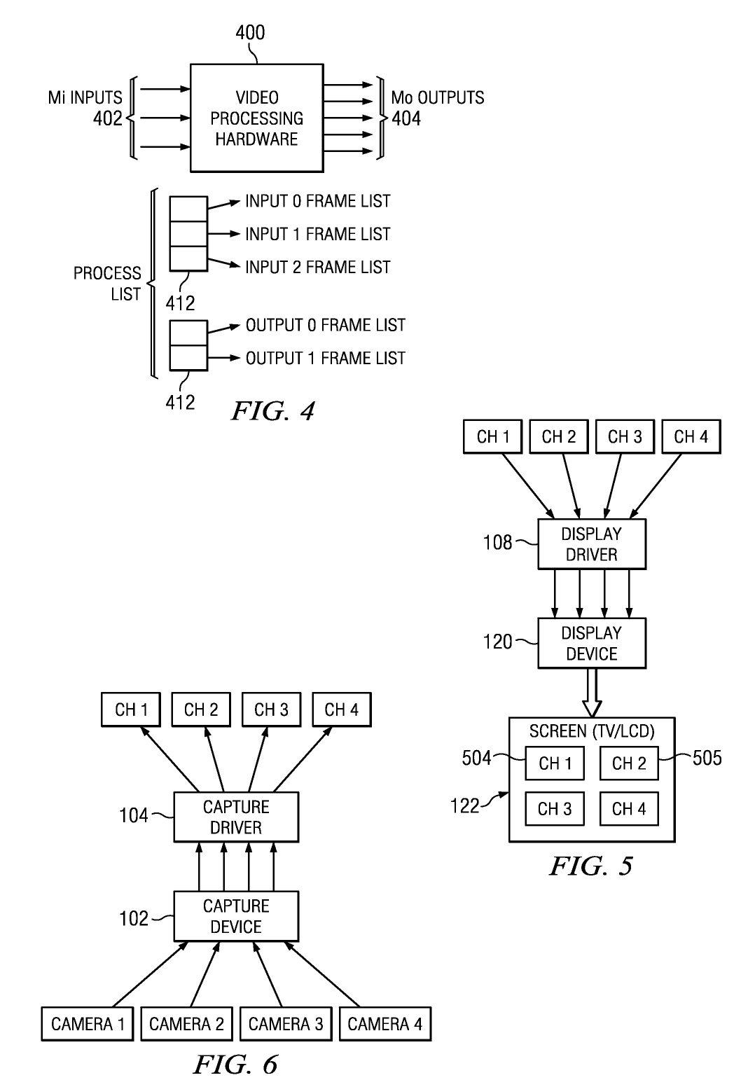

FIG. 4 illustrates a relation between video processing hardware 400 and process lists. Advanced video processing hardware may require multiple inputs 402 and generate multiple outputs 404. For example, noise filter hardware typically requires a previous frame and a current frame for temporal noise reduction. Similarly multiple size outputs may be generated using a single scalar hardware. In the case of video processing drivers, there may be a need for multiple input and output frame lists depending upon number of inputs and outputs. Also the multi-window mode of memory operation is supported using frames and a frame list.

A process list is a list of pointers to a collection of frame lists. A process list represents M frame lists for input and output frames. Each frame list represents a Nx frame buffers for each of the inputs and outputs. For example, process list 412 points to frame lists for the multiple inputs of processor 400, while process list 412 points to frame lists for multiple outputs of processor 400. As multiple channels are captured, the improved driver interface provides a mechanism for all of them to be processed in the single request; the interface allows submission of all frames to each driver.

Meta data may be included with one of the frames in a frame list and may be selectively applied to that frame, to all of frames of a frame list or to all frame lists of a process list. Meta data may be included with one of the frame lists that is selectively applied to all of the frames of the frame list or to all frame lists of the process list. Meta data may be included with a process lists that is selectively applied to the all of frames of the frame lists or to all frame lists of the process list.

FIG. 5 is a flow diagram illustrating a portion of system 100 that performs multi-window processing for multi-window display 122. In this system, buffers for the various channels Ch(1-4) may be scattered in memory. Display driver 108 with the help of display hardware performs the composition of the different channel buffers according to the display layout. To support multi-window display/video composition operation or single frame display, a frame list is used to queue buffers to display driver 108 and dequeue buffers from display driver 108. Here each window, such as windows 504-505, is represented by a frame pointer in a frame list. With this new interface, the application call queues the video buffers for all the windows using a single call and thus reduces software overhead. The same interface may be used for processing drivers where the input buffer is scattered across memory.

FIG. 6 is a flow diagram illustrating another portion of system 100 that illustrates a typical multi-channel capture system. To support multi-channel capture operation, again the same frame list is used. Here each capture channel Ch(1-4) is represented by a frame pointer in frame list.

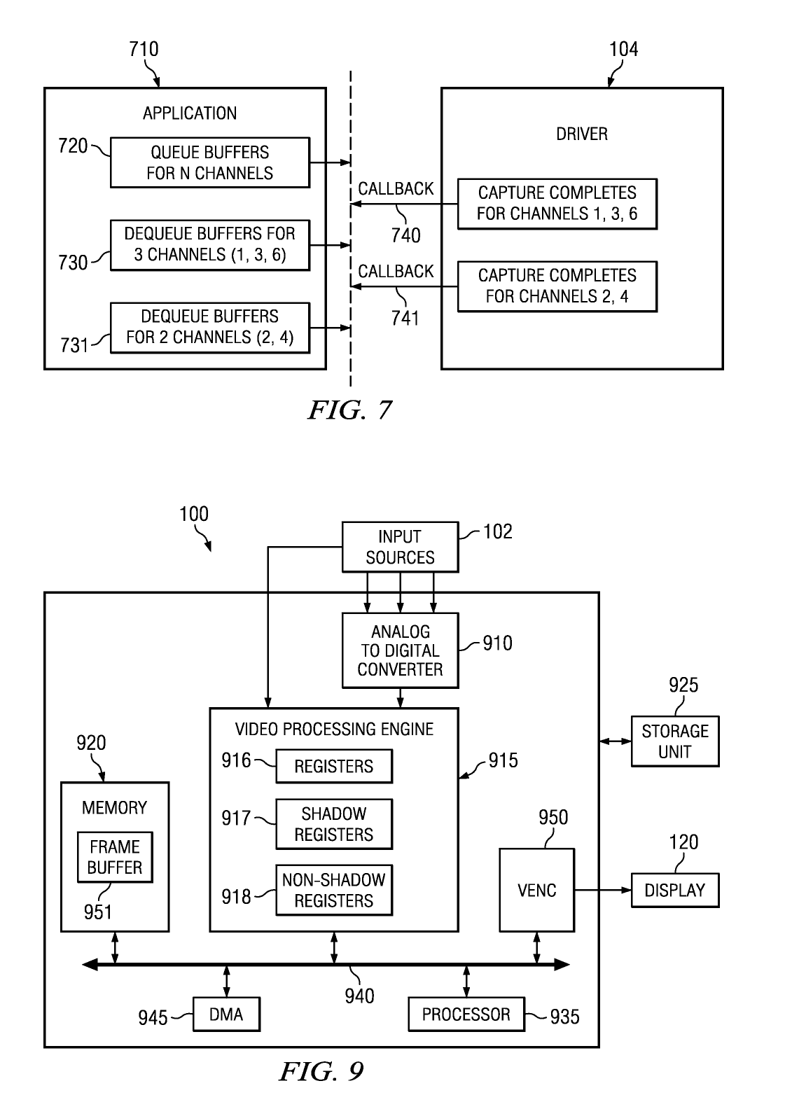

FIG. 7 is a flow diagram illustrating single queue, multiple dequeue operations. While starting a capture driver, application 710 submits buffers for all the channels using Queue call 720. Since multiplexed inputs could be asynchronous, capture could complete at different time for each of the inputs. Application 710 wants to process the buffers as soon as they are captured. Hence they are de-queued immediately without waiting for other channels to complete. This will result in multiple dequeue for a single queue. For example, dequeue 730, 731 may be performed in response to callback 740, 741 respectively. Thus, callback 740 “initimates' that some, but not necessarily, all frames have been processed as requested.

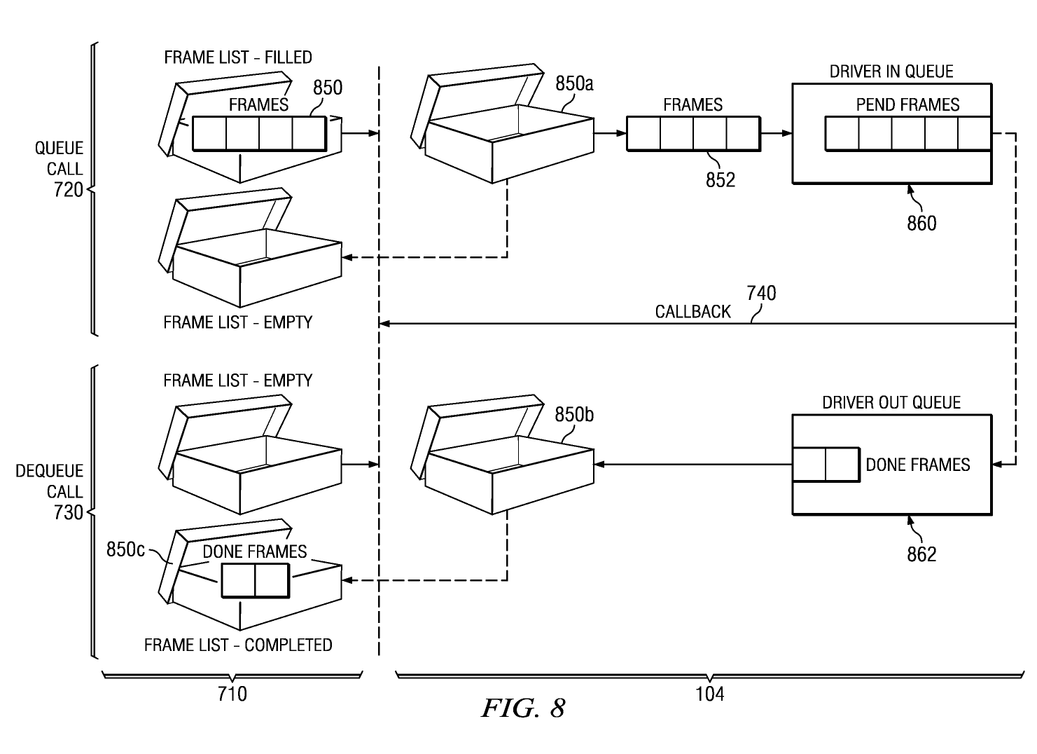

FIG. 8 illustrates the use of frame lists for the multiple dequeue operation Illustrated in FIG. 7. In a traditional driver model, multiple dequeue operations would be a problem as each queue and dequeue operation is linked. So to solve this issue, embodiments of the invention de-link the queue and dequeue operation. The frame list used in queue and dequeue operation is not queued inside the driver. Only the frames contained inside the frame list are queued. The frame list acts like a container to submit the frames to the driver in Queue call and take back the frames from the driver in dequeue call. For queue call, application is free to re-use the same frame list again without dequeuing. For dequeue call, the application has to provide the frame list to the driver and the driver copies the captured frame to the frame list.

For example, frame list 850 is provided to driver 104 by queue call 720 by an application being executed on video processing system 100. The frames 852 included in frame list 850 are queued in input queue 860 of driver 104, however, the frame list remains available, but empty, to application 710 as indicated at 850a. When driver 104 completes processing one or more frames, it issues callback 740 to intimate to application 710 that a completed frame is available. In response, application 710 may issue dequeue call 730 to retrieve the completed frame and begin a next stage of processing on the frame. The empty frame list is provided to driver 104, as indicated at 850b and driver 104 inserts each completed frame that is in its output queue 862 to frame list 850b. Application 710 may then use the partially filled frame list, as indicated at 850c, to request another processing operation.

Runtime Configuration on a Frame by Frame Basis:

Runtime configurations of video parameters like positioning, scaling ratio etc are supported by having pointer to runtime structures in each of the frame or frame list structures. The application can decide which one to use based on whether it has to change the parameters for a frame or for a group of frames for all the channels or windows. This is again a contract between application and driver and runtime parameters are opaque to this improved driver interface. This means the same interface can be used for any kind of video application.

With all the above features of the improved video driver interface, it can be seen that the same frame and frame list has been used for capture, display and memory operation. Hence this allows capture frames list to be passed for memory operations and output of memory operation also generates frame list which could be passed over to display. This totally eliminates need of data structure copy while calling different class of APIs like capture, display and memory operations.

FIG. 9 is a block diagram of video processing system 100 in the form of an electronic device that embodies the invention. Electronic device 100 may embody a digital video recorder/player, a mobile phone, a television, a laptop or other computer or a personal digital assistant (PDA), for example. A plurality of input sources 102 may feed video to an analog-to-digital converter (ADC) 910. Examples of input sources 102 include a camera, a camcorder, a portable disk, a storage device, a USB or any other external storage media. ADC 910 converts analog video feeds into digital data and supplies the digital data to video processing engine (VPE) 115. As illustrated in FIG. 9, digital video feeds from digital sources such as a digital camera may be provided directly to VPE 915 from digital input sources 102. The VPE 915 receives the digital data corresponding to each video frame of the video feed and stores the data in a memory 920 under control of a capture driver. Multiple frames may be stored corresponding to a video channel in a block of memory locations and referred to with a frame list, as described in more detail above.

VPE 915 includes a number of registers that control the operation of VPE 115. For example, there are various active registers 916 that are paired with shadow registers 917. Shadow registers 917 may be loaded at any time and then be transferred in parallel to active registers 916 in response to a control signal. Non-shadow registers 918 are active registers that are not paired with a respective shadow register. As soon as each non-shadow register 918 is loaded by writing new control data to it, it immediately reflects the new control data on its output. Meta data included with a frame, a frame list or a process list may be used by a processing driver to update the various registers and shadow registers in order to control the operation of VPE 915.

An application being executed on processor 935 uses a frame list to retain frame pointers to the block of memory locations corresponding to each channel of video from each input device. The application can request the VPE perform different functions for different channels. As an example, a video stream coming from a camera may be down scaled from 1920 by 1080 pixels to 720 by 480 pixels and a second video stream coming from a hard disk or a network may be upscaled from 352 by 288 pixels to 720 by 480 pixels. The application can also perform one or more functions such as indicating size of the input video, indicating size of the output video or indicating a re-sizing operation to be performed by the VPE 915. Re-sizing can include upscaling, downscaling and cropping of frames dependent on various factors such as image resolution, etc. For example, two input videos having 720 by 480 pixel frames can be re-sized into output videos of 352 by 240 pixel frames by the VPE 915. The input videos can then be combined and provided to a display 120 through a communication channel. The re-sized output videos can also be stored in memory 920. In some embodiments, a processor 935 in communication with the VPE 915 includes the application that performs the one or more functions. Examples of a processor 935 include a central processing unit (CPU), a reduced instruction set processor (RISC), and a digital signal processor (DSP) capable of program controlled data processing operations. In some embodiments, some of the video processing may also be performed by processor 935 in connection with VPE 915.

A video decoder component within VPE 915 decodes frames in an encoded video sequence received from a digital video camera in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), ITU-T/ISO High Efficiency Video Coding (HEVC) standard, etc. The decoded frames may be provided to a display driver for video encoder 950 for display on a display device 120 using a frame list, as described in more detail above.

Video encoder (VENC) 950 creates a complete video frame including active video data and blanking data and it does some video processing, such as converting from digital data to analog, converting from RGB to YUV etc. The output of VENC is typically connected to a TV or a display device, such as display device 120.

Direct Memory Access (DMA) engine 945 is a multi-channel DMA engine that may be used to transfer data between locations in memory 920 and memory mapped locations in Video processing engine 915, VENC 950 and processor 935, for example by using interconnect fabric 940. Additional memories and other peripheral devices, not shown, may also be accessed by DMA 945. In particular, registers 916, shadow registers 917 and non-shadow registers 918 in VPE 915 may be accessed and loaded by DMA 945.

The disclosure herein describes a video driver interface that can support all types of video drivers. This interface supports multi-window display, multi-channel capture, video composition on video processing drivers and runtime configuration on a frame by frame basis. This interface also eliminates the need of moving data from one structure to another structure across different class of drivers like display, capture and memory to memory.

Since the interface and data structures are the same for display, capture and memory drivers, an application can easily link various drivers and pass the frames from one driver to the next driver with less manipulation. This means that the application complexity and CPU usage may be reduced.

### Other Embodiments

While the invention has been described with reference to illustrative embodiments, this description is not intended to be construed in a limiting sense. Various other embodiments of the invention will be apparent to persons skilled in the art upon reference to this description. Embodiments of the system and methods described herein may be provided on any of several types of digital systems: digital signal processors (DSPs), general purpose programmable processors, application specific circuits (ASIC), or systems on a chip (SoC) such as combinations of a DSP and a reduced instruction set (RISC) processor together with various specialized accelerators. An ASIC or SoC may contain one or more megacells which each include custom designed functional circuits combined with pre-designed functional circuits provided by a design library. DMA engines that support linked list parsing and event triggers may have different configurations and capabilities than described herein may be used.

Embodiments of the invention may be used for systems in which multiple monitors are used, such as a computer with two or more monitors. Embodiments of the system may be used for video surveillance systems, conference systems, etc. that may include multiple cameras or other input devices and/or multiple display devices.

A stored program in an onboard or external (flash EEP) ROM or FRAM may be used to implement aspects of the video processing. Analog-to-digital converters and digital-to-analog converters provide coupling to the real world, modulators and demodulators (plus antennas for air interfaces) can provide coupling for waveform reception of video data being broadcast over the air by satellite, TV stations, cellular networks, etc or via wired networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the previous discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method of operating an electronic device including a program controlled data processor and at least one video processing hardware responsive to requests to perform operations on video frames, the method comprising the steps of:
forming a first frame list with pointers to a plurality of frames for a corresponding plurality of video channels;
forming a request by an application program running on the data processor for a first operation on each of the plurality of frames in the first frame list;
submitting the request of the application program and the first frame list to a driver for the video processing hardware; and
receiving a notification from the driver when the video processing hardware has completed the operation on less than all of the plurality of frames.

2. The method of claim 1, further comprising:
forming a process list that includes one or more frame lists;
forming a request for a video processing operation on the process list; and
submitting the request for video processing and the process list to the driver for the video processing hardware.

3. The method of claim 2, wherein the process lists includes one or more input frame lists and one or more output frame lists.

4. The method of claim 2, wherein the first frame list is one of the input frame lists.

5. The method of claim 1, further comprising submitting a request for a second operation on each of the plurality of frames of the frame list to another driver in response to a notification from the driver that the video processing hardware has completed the first operation on less than all of the plurality of frames.

6. The method of claim 1, wherein a request includes frames from multiple channels, which are composited and displayed as a single frame on a display device.

7. The method of claim 2, wherein meta data is included with one of the plurality of frames that is selectively applied to that frame, to the plurality of frames of the frame list or to all frame lists of the process list.

8. The method of claim 2, wherein meta data is included with one of the frame lists that is selectively applied to the plurality of frames of the frame list or to all frame lists of the process list.

9. The method of claim 2, wherein meta data is included with the process list that is selectively applied to the plurality of frames of the frame lists or to all frame lists of the process list.

10. A video processing device comprising:
a program controlled data processor coupled to at least one video processing module responsive to requests to perform operations on video frames;
a memory coupled to the data processor holding an application program and driver, wherein the driver is configured to:
receive from the application program a first frame list with pointers to a plurality of frames for a corresponding plurality of video channels;
receive from the application program a request for a first operation on each of the plurality of frames in the first frame list;
submit the request of the application program and the first frame list to for the video processing hardware for the plurality of channels; and
notify the application program when the video processing hardware has completed the operation on less than all of the plurality of frames.

11. The device of claim 10, wherein the driver is further configured to:
receive a process list that includes one or more frame lists;
receive a request for a video processing operation on the process list; and
submit the request for video processing and the process list to the video processing hardware.

12. The device of claim 2, wherein the process lists includes one or more input frame lists and one or more output frame lists.

13. The device of claim 11, wherein the driver is further configured to notify the application program that a portion of the submitted request operations have completed before all of the submitted request operations have completed.

14. A method of operating a driver on an electronic device including a program controlled data processor and at least one video processing hardware responsive to requests to perform operations on video frames, the method comprising the steps of:
receiving from an application program running on the data processor a first frame list with pointers to a plurality of frames for a corresponding plurality of video channels;
receiving a request from the application program for a first operation on each of the plurality of frames in the first frame list;
submitting the request of the application program and the first frame list to the video processing hardware for the plurality of channels; and
notifying the application program when the video processing hardware has completed the operation on less than all of the plurality of frames.

15. The method of claim 14, further comprising:
receiving a process list that includes one or more frame lists;
receiving a request for a video processing operation on the process list; and
submitting the request for video processing and the process list to the video processing hardware.

16. The method of claim 15, wherein the process lists includes one or more input frame lists and one or more output frame lists.

17. The method of claim 14, further comprising receiving a request for a second operation on each of the plurality of frames of the frame list in response to a notification from another driver that the video processing hardware has completed another operation on less than all of the plurality of frames.
